(19) United States
(12) Patent Application Publication
(10) Pub. No.: US 2014/0305390 A1
(43) Pub. Date: Oct. 16, 2014

(54) METHOD AND APPARATUS FOR CONTROLLING AN INTERNAL COMBUSTION ENGINE WHEN A MISFIRE IS DETECTED

(71) Applicant: EC POWER A/S, Hinnerup (DK)

(72) Inventors: Jesper Forster, Risskov (DK); Lars Lüders, Norresundby (DK); Søren Stig Abildgaard, Skodstrup (DK); Steven Lose, Dianalund (DK); Kim Tae Ho, Hojbjerg (DK)

(21) Appl. No.: 14/356,199

(22) PCT Filed: Nov. 6, 2012
(86) PCT No.: PCT/EP2012/071944

§ 371 Date: May 5, 2014

(30) Foreign Application Priority Data
Nov. 7, 2011 (GB) 1119239.0

(51) Int. Cl. F02B 63/04

(52) U.S. Cl. CPC F02B 63/04
USPC 123/2

(57) ABSTRACT

An engine-generator comprises: a generator 13, an internal combustion engine 14 coupled to the generator 13 such that operation of the internal combustion engine 14 will generate electricity via the generator 13, and a control system incorporating a misfire detection system 5, the misfire detection system 5 being arranged to monitor engine rotation speed in order to detect a misfire event during operation of the engine 1; wherein in response to an indication of the misfire event the control system initiates a safety mode of the engine-generator.

The invention relates to an engine-generator incorporating a misfire detection system for an internal combustion engine of the engine-generator.

A engine-generator uses mechanical energy from a prime mover and generates electricity via the relative motion of electrical and magnetic components. For many applications the generator will use rotational energy supplied by an internal combustion engine. Mechanical energy from the prime mover is converted into electrical energy by movement of a rotor relative to a stator. A combined heat and power (CHP) device is an example of an engine-generator and can be made up of a generator and an internal combustion engine. The internal combustion engine is fitted with heat exchangers and the like for recovery of heat. The generator is used to convert the mechanical energy produced by the engine into electricity.

It is known for internal combustion engines to incorporate a misfire detection system (MDS). A misfire may occur through the presence of an incorrect fuel/air mixture, poor quality or old spark plugs, incorrect ignition timing or a missing ignition arising from a fault. In vehicles misfire detection systems are used for detecting a problem with the engine and can be used to schedule servicing or to identify incorrectly operating parts. When misfires occur the fuel will be incompletely combusted. In vehicles the misfire detection system can also therefore used to protect the catalytic converter. For vehicles, misfire detection is a well developed technology, but the misfire detection is not designed to detect every single misfire and they are not capable of effectively detecting misfires occurring infrequently or in isolation. It is acceptable for vehicle based systems to fail to detect misfires since this does not result in a significant disadvantage. The focus is on improving engine efficiency and on avoiding damage to the catalytic converter and other engine parts and the detection of misfires is not for reasons of safety. Indeed, the presence of uncombusted fuel in the exhaust, causing backfires and other outputs of noise and flames from the exhaust is tolerated and sometimes even designed into a car. As a result of the immediate dilution of uncombusted fuel in the atmosphere there is no reason to consider a misfire detection system for a vehicle that is focussed on safety and on avoiding even low levels of uncombusted fuel in the exhaust.

For an engine-generator the considerations relating to misfires and the need for detection of misfires are significantly different to those in relation to vehicles. In contrast to vehicles, where safety is not a primary concern, a misfire detection system for an engine-generator should be focussed on safety. An engine-generator may be operated in a confined space and in the case of a CHP system the exhaust gases may be conveyed through various heat exchangers and a flue system before being diluted by the outside air. It is important to identify misfires and to initiate a safe mode in response to a misfire event before a dangerous build-up of gases occurs. A flue system might be more than 20 metres long with a diameter of 100 mm of above. Such a flue system can hence contain a large volume of exhaust gases undiluted by the outside air. A build-up of incompletely combusted fuels in a confined space gives rise to a serious explosion risk If an explosion or some other fault allows the exhaust to escape into a building or other inhabited space the this will be a serious a poisoning risk, for example carbon monoxide poisoning. In a vehicle the exhaust gases are quickly vented to atmosphere and hence although a continued misfire may have a detrimental environmental effect, there is limited risk of danger to the user. Thus, a misfire detection system for a vehicle would not be obviously applied to an engine-generator and moreover it will not operate a safety mode in response to a misfire event. Indeed, it could be dangerous for a vehicle to shut down the engine or put it into some safe running mode since the driving conditions may require the engine to operate at full capacity to allow the driver to manoeuvre the vehicle safely.

With an engine-generator in an enclosed space and in particular a system operating in an inhabited building such as a home, school or hospital it is highly important to operate a safety mode when a misfire is detected. It is also highly important to detect misfires quickly and with a “fail safe” methodology. Otherwise serious injury or death could occur.

It is known in existing engine generator systems to stop the operation of the engine when there is a fall in the electrical power output of the engine-generator. An example of such a system is in use with the “XRGi 15G” CHP device manufactured by EC Power A/S of Denmark. The fall in power output occurs as a result of ongoing inefficient combustion, which will generally be caused by misfires. The XRGi 15 device uses a lean fuel mix and so the air/fuel intake includes a large amount of air. As a result the exhaust is diluted with air even before it exits the CHP device. This means that it is safe to use the engine-generator power output as a means to indicate an ongoing misfire, since a significant build up of gas is required before there is a serious risk of explosion or poisoning.

However, such a system is not suited to all engine-generators. In particular, the inventors have made the non-obvious realisation that when the fuel mix is not a lean mixture, then the use of a power output based system may not be fast enough at detecting a misfire to maintain safety.

Viewed from a first aspect, the invention provides an engine-generator comprising: a generator, an internal combustion engine coupled to the generator such that operation of the internal combustion engine will generate electricity via the generator, and a control system incorporating a misfire detection system, the misfire detection system being arranged to monitor engine rotation speed in order to detect a misfire event during operation of the engine; wherein in response to an indication of the misfire event the control system initiates a safety mode of the engine-generator.

The use of a measurement of engine rotation allows a misfire event to be detected considerably faster than with the prior art engine-generator misfire detection systems. A misfire event in this context is an occurrence of misfires that is considered to generate a safety risk or a risk of damage to the engine-generator. It is particularly important to detect a misfire event quickly when a rich mixture is being used. This is because the fuel content of the exhaust from a misfiring engine with a richer fuel mixture is considerably higher. When the higher fuel content exhaust builds up in an enclosed space or within an exhaust system used for heat recovery then it is possible for an explosive mixture to build up before the power output of the engine-generator has dropped sufficiently to trigger a safety alert. The prior art engine-generator misfire detection systems using a power output measurement hence cannot meet the performance of the above described system, which uses an engine rotation speed.

Clearly, an engine-generator including the above described misfire detection system has advantages whatever the fuel mixture and fuel type, since a faster detection of a misfire event will always increase the safety of the system. Thus, the misfire detection system may be advantageously applied to engines using lean fuel mixtures as well as rich fuel mixtures. However, particular advantages arise when the engine uses a relatively rich mixture, such as a so-called “lambda 1” or stoichiometric mixture. Hence, in preferred embodiments the engine-generator is one using an air-fuel mixture with a lambda value of 1.3 or below, preferably 1.0 or below.

The fuel used may be any conventional fuel, including natural gas, biofuels, hydrogen fuels and so on. The engine may be a spark ignition engine, with the fuel being selected appropriately, although application of the invention is not limited only to spark ignition engines. In one preferred embodiment the engine-generator uses natural gas as the fuel. Gasoline fuels may also be used.

The safety mode may including switching of the engine to a safe running mode or turning the engine off. Preferably the safety mode comprises cutting off of the fuel supply.

After the fuel supply is cut off, the engine may continue to run for a period, for example, 15 seconds or so, or about 300-400 revolutions. Advantageously this allows for the engine to be ventilated with air in order to expel any remaining fuel from the engine and/or exhaust system to the atmosphere. During this additional running time the generator pulls the engine. The engine may then be shut down. The shutdown of the engine is preferably a shutdown that requires a manual reset before the engine can be restarted. The use of a manual reset ensures that trained personnel are present and can check the operation of the engine and ensure that the fault that caused the misfire(s) is rectified before the engine-generator is restarted.

In an alternative implementation, the engine may not be fully stopped, but causes and solutions for misfire may be evaluated and repaired “on the fly”, and the fuel supply is then re-established and the engine put back to operation without being stopped. With this feature the misfire detection system or a control system of the engine may be arranged to alert a remote monitoring station, which can then access engine data and diagnostics and carry out a repair. This approach can be of benefit when misfires are cause by faults with the engine management software, for example.

The engine rotation speed may be rotation of any part driven by the combustion cycle of the engine. Hence, the misfire detection system can be applied to any engine that has an appropriate device for to measurement of rotation of such parts or can be equipped with a suitable measurement device. The misfire detection system may monitor changes in the engine rotation speed and/or the rate of change of engine rotation speed, i.e. the acceleration of the rotating part(s).

In preferred embodiments the engine rotation speed is a rotation speed of a crankshaft and/or camshaft, which may be measured by means of crank and/or cam sensors. The crank and cam sensors may be of conventional type, for example they may the same sensors that are conventionally used for ignition timing. The engine rotation speed may include a crank rotational speed, i.e. the rpm output of the engine crankshaft. The engine rotation speed may alternatively or additionally include a camshaft rotational speed. The rotational speed of the crank and cam is directly linked to the power input from combustion in the combustion chamber of the engine. Hence, by measuring these rotational speeds the misfire detection system receives a direct indication of an immediate change to the engine's operating characteristics that occurs following a misfire, since compared to a correct combustion event a misfire will give rise a different change in momentum of the rotating parts of the engine.

It will be appreciated that with an engine-generator the volume of incompletely combusted exhaust gas is of great significance. Existing standards relating to misfire detection include requirements for a minimum time from the misfire to the detection of the misfire. Such systems would not be sufficiently safe for an engine-generator using a lambda 1 or rich fuel mixture, since with a continued misfire an unsafe volume of gas could build-up even before such a minimum time has elapsed. With an engine-generator it is highly important to know the potential number of misfires that have occurred and to detect them very quickly. With a lambda 1 fuel mixture and a typical engine size an unsafe level of incompletely combusted gas may arise even if only a small number of ignitions are missed, for example five ignitions for some engines. This means that an effective misfire detection system should be able to detect misfire events that comprise five misfires or even less, and this detection should occur in a fail safe fashion. Clearly it is better to provide a false indication of a misfire than to fail to detect an actual misfire.

The misfire event may comprise a number of potential misfires exceeding a maximum permitted number, the potential misfires being determined based on the measurement of a rotational speed of the engine. The maximum number of potential misfires may be a maximum within a set time limit or within a set number of engine combustion cycles, this maximum being set based on a determination of a safe level for the build up of incompletely combusted fuel. In a preferred embodiment, the misfire detection system is arranged to indicate a misfire event if the number of ignition strokes with potential misfires exceeds 10%, preferably 8% of strokes within a preset total number of strokes, for example 1000 or 600 strokes, or less. Thus, 90% or preferably 92% of strokes should not be a misfire.

In a preferred arrangement, the misfire detection system determines a potential misfire by determining when a cylinder fires correctly and identifying a potential misfire when an expected fire is not detected. When the engine fires the rotation of the crankshaft will accelerate and increase in speed. If a misfire occurs then the crankshaft will not accelerate. Thus, the misfire detection system may monitor the rotation speed of the crankshaft and watch for expected fires, with a potential misfire being indicated when the expected acceleration or increase in speed does not occur. Preferably the misfire detection system measures the engine speed and determines that a fire has occurred when the change in engine speed, the maximum acceleration or the acceleration at the midpoint of the fire stroke exceeds a threshold value. By looking for the acceleration or change of speed that occurs with a correct engine fire event and indicating a potential misfire when such acceleration or change of speed is not present or when it is below a threshold value, the misfire detection system can ensure that all misfires are detected, without any potential misfires being missed. With an engine-generator, compared to a vehicle misfire detection system it can be more difficult to detect a potential misfire based on deceleration or a lack of acceleration of the engine, since the generator can act as a motor and cause the engine to continue to rotated even when a misfire occurs.

Preferably the camshaft speed of rotation is measured in addition to measurement of the rotational speed of the cam crankshaft shaft. The camshaft rotation may be used to determine the timing for detection of expected engine fires. Thus, the camshaft rotation is preferably used to determine where the engine is within its combustion cycle.

The misfire detection system may use a threshold value for engine rotational speed to indicate the potential misfire event. Thus, the misfire detection system may be arranged to measure the engine rotational speed, for example by measurement of the crankshaft rotational speed, with a potential misfire being indicated when the engine rotational speed drops below a threshold value. As noted above a misfire detection system using engine rotational speed in this way can be applied to any engine that has an appropriate device for to measurement of rotation of such parts or can be equipped with a suitable measurement device. Preferably, if the engine rotational speed continues to be below the threshold value during a number of number of strokes then the misfire detection system indicates a continuous misfire, i.e. a potential misfire occurring at every stroke of the engine when the speed is too low. Once again, the safety mode of the engine may be initiated when the number of potential misfires exceeds a preset limit.

With an engine-generator, in contrast to a vehicle engine, the rotational speed of the engine is usually steady and at a set level that is determined based on the generator characteristics and on the required frequency of electrical power generation. The inventors have found that the rotational speed of the engine in an engine-generator can be used as an indicator of potential misfire(s) In a vehicle the rotational speed of the engine will vary greatly and therefore cannot be used as an indicator of potential misfires. With an engine-generator the generator will act as a motor and can apply a torque to the engine, causing it to continue rotating even when there is a misfire or continued misfire. However, the inventors have made the realisation that in an engine-generator, despite this effect, the occurrence of multiple or continuous misfires will still lead very quickly to a drop in rotational speed of the engine, and this speed drop can therefore be used as an effective indicator of a misfire event for the engine-generator. In common with the crankshaft acceleration based indication of a misfire described above this technique also has the advantage of providing a fail safe mechanism. A continuous misfire will be detected by this system, and although it is possible that the indication of a misfire event may be triggered by some other engine failure, in view of the safety aspects of the engine-generator misfire detection system it is preferable to provide a false positive than to fail to detect a misfire.

Thus, in one preferred embodiment the misfire detection system indicates that a potential misfire has occurred when the engine rotational speed drops below a threshold value. The engine rotation speed is preferably measured for every stroke, and then extrapolated to give a value of revolutions per minute (RPM) or similar. For a given stroke, a potential misfire is indicated if the rotational speed is below the threshold value. The drop in engine rotational speed may optionally be measured as an average over a period of time or over a number of engine revolutions or ignition cycles. This will smooth out irregularities in engine speed that occur as a result of other factors. The threshold value may be set as a percentage below the expected engine rotational speed for steady state operation, which is may be operation at the synchronous speed of the generator. For example, it may be a speed of 2% or more below the expected engine rotational speed for steady state operation. For a typical engine-generator producing 50 Hz AC the threshold value may be 1500 revolutions per minute (RPM).

Preferably, the misfire detection system is arranged to adjust the threshold value in response to changes in the frequency of electricity in the grid or network to which the generator is attached. Such changes may occur due to variations in the grid frequency, which occur relatively frequently in some regions. Thus, the misfire detection system may receive an indication of frequency and be arranged to adjust the threshold engine rotation value accordingly. The misfire detection system may include or be in communication with phase detectors that measure the frequency of electricity production or the grid frequency. In a preferred embodiment the frequency of the grid is measured by averaging the frequency over 15 full sinusoidal cycles, which may be done by buffering and summing the last 30 half periods, before calculating the average frequency and thereby determining the synchronous speed of the generator. In the preferred embodiment there is a direct connection of the generator to the engine output shaft, and so the generator RPM will be identical to the engine RPM. When the generated frequency is 50 Hz, which is equivalent to an engine speed of 1500 RPM, the frequency measurement over 15 sinusoidal cycles will occur over 3.75 ignition cycles or 7.5 revolutions of the engine.

The above described acceleration detection and threshold rotational speed techniques can be used independently to detect misfires. However, it is preferred to combine both systems, with a misfire event being indicated either as a consequence of a lack of detection of engine fires or as a consequence of engine rotation speed dropping below a threshold value. The threshold value may be as above, the misfire event based on detecting engine fires may be indicated when the number of potential misfires is above a maximum number, as described above. Combining both techniques means that the misfire detection system can effectively detect both intermittent misfires and multiple or continuous misfires. The use of crankshaft acceleration is highly effective in detecting isolated misfire events, and the use of a minimum threshold engine rotation speed is effective in detecting multiple or continuous misfires.

The misfire detection system may be arranged to correlate the detected potential misfire(s) with pulses of the crank sensor or cam sensor and to hence indicate the cylinder or cylinders of the engine where the misfire(s) take(s) place. Thus, the misfire detection system may be arranged to provide an indication of potentially damaged or faulty parts, such as damaged or worn out spark plugs, or damaged ignition components.

In a preferred embodiment the misfire detection system has a redundant architecture. Thus, the software and/or hardware may comprise multiple similar misfire detection modules, which are preferably arranged to perform a periodic reciprocal comparison to confirm that both modules are operating correctly and producing the same result. The misfire detection system may initiate the safety mode of the engine in the event that the reciprocal comparison indicates that the two modules are not producing the same result.

It will be appreciated from the discussion above that the system of the invention has particular efficacy when the engine-generator is a part of a CHP device. This is because there is a greater risk of explosion when the exhaust gases are used for heat recovery since as much as 10 litres or more of exhaust gases may be contained within the heat exchangers, and an explosive mixture including uncombusted fuel can easily build-up. Hence, the invention extends to a combined heat and power device including the engine-generator described above.

The control system may be a dedicated system for misfire detection and hence may comprise only the misfire detection system. Alternatively, the control system may be a wider system for control of other aspects of the engine and/or generator, and hence the misfire detection system may be incorporated into a wider control system.

Viewed from a second aspect, the invention provides a method of controlling an engine-generator comprising a generator and an internal combustion engine coupled to the generator such that operation of the internal combustion engine will generate electricity via the generator, the method comprising: monitoring engine rotation speed; determining the occurrence of potential misfires using the monitored engine rotation speed in order to thereby detect a misfire event during operation of the engine; and, in response to an indication of the misfire event, initiating a safety mode of the engine-generator.

The method of the invention may be used with an engine-generator incorporating any or all of the features described above in connection with the first aspect of the invention.

The step of initiating the safety mode may comprise switching of the engine to a safe running mode. In a preferred embodiment the step of initiating the safety mode comprises shutdown of the engine, which is preferably a shutdown that requires a manual reset before the engine can be restarted.

The step of monitoring the engine rotation speed may include monitoring rotation of any part driven by the combustion cycle of the engine. In preferred embodiments the engine rotation speed is a rotation speed of a crankshaft and/or camshaft, which may be measured by means of crank and/or cam sensors.

The misfire event may comprise a number of potential misfires exceeding a maximum permitted number, the potential misfires being determined based on the monitoring of a rotational speed of the engine. The maximum number of potential misfires may be a maximum within a set time limit or within a set number of engine combustion cycles, as discussed above.

A preferred method includes determining a potential misfire by determining when a correct combustion event or engine fire occurs and identifying a potential misfire when an expected engine fire is not detected. Hence, the step of monitoring the rotation speed of the crankshaft may comprise monitoring acceleration or change in speed of the crankshaft, identifying if an expected acceleration or change in speed occurs, and hence determining that a misfire has occurred by the absence of this expected acceleration. The method may include determining that a fire has occurred when the change in engine speed, the maximum acceleration or the acceleration at the midpoint of the fire stroke exceeds a threshold value.

The step of determining the occurrence of potential misfires may comprise comparing the engine rotation speed to a threshold value, with potential misfires being indicated by an engine rotation speed dropping below the threshold value. Thus, the method may indicate a misfire event when the engine rotation speed drops below the threshold value. The engine rotation speed may be rotation of any part driven by the combustion cycle of the engine. The monitoring of engine rotation speed may include measuring the crankshaft rotational speed. The threshold value may be set as described above.

The method preferably includes adjusting the threshold value in response to changes in the frequency of electricity production. The method may include receiving an indication of frequency and adjusting the threshold engine rotation value accordingly. The indication of frequency may be received from a phase detector that monitors the generator frequency or the grid frequency.

The method may include correlating the detected potential misfire(s) with pulses of the crank sensor or cam sensor and thereby indicating the cylinder or cylinders of the engine where the misfire(s) take(s) place.

The above described acceleration detection and threshold rotational speed steps can be used independently to detect misfires. However, it is preferred to combine both systems, with a misfire event being indicated either as a consequence of a lack of detection of engine fires or as a consequence of engine rotation speed dropping below a threshold value.

Certain preferred embodiments of the invention will now be described by way of example only and with reference to the accompanying drawings, in which:

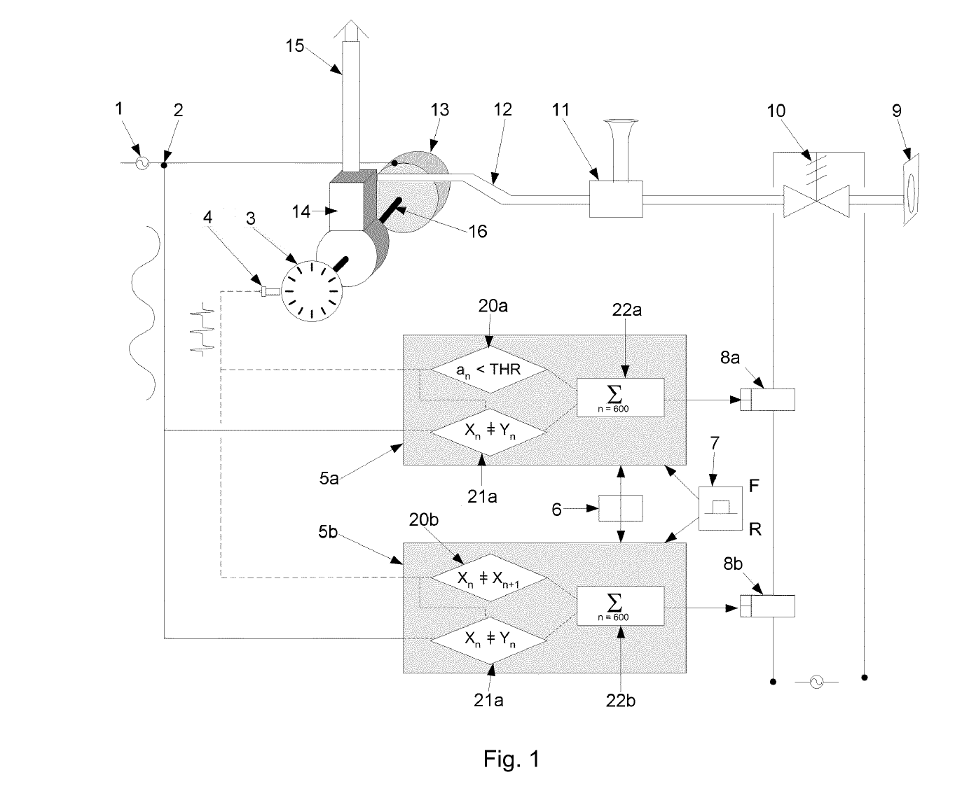

FIG. 1 is a schematic diagram of an engine-generator including a misfire detection system in accordance with a preferred embodiment;

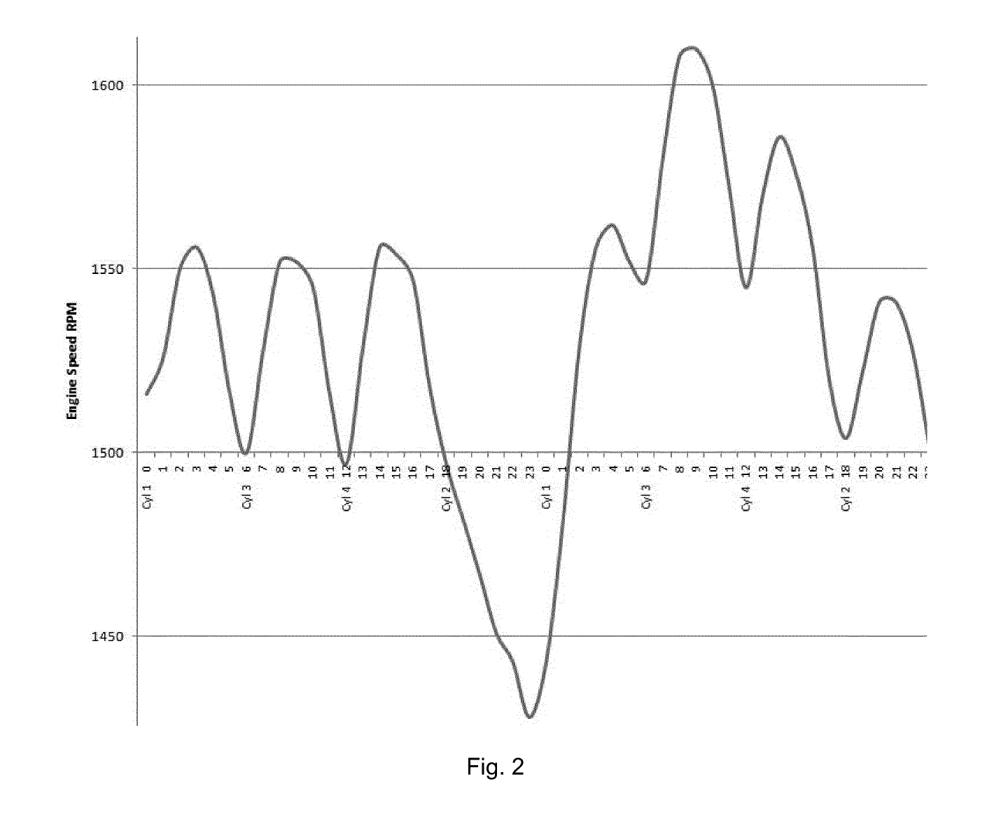

FIG. 2 is a plot of engine speed in RPM against crankshaft position over four revolutions of a four cylinder four stroke engine in an engine-generator; and

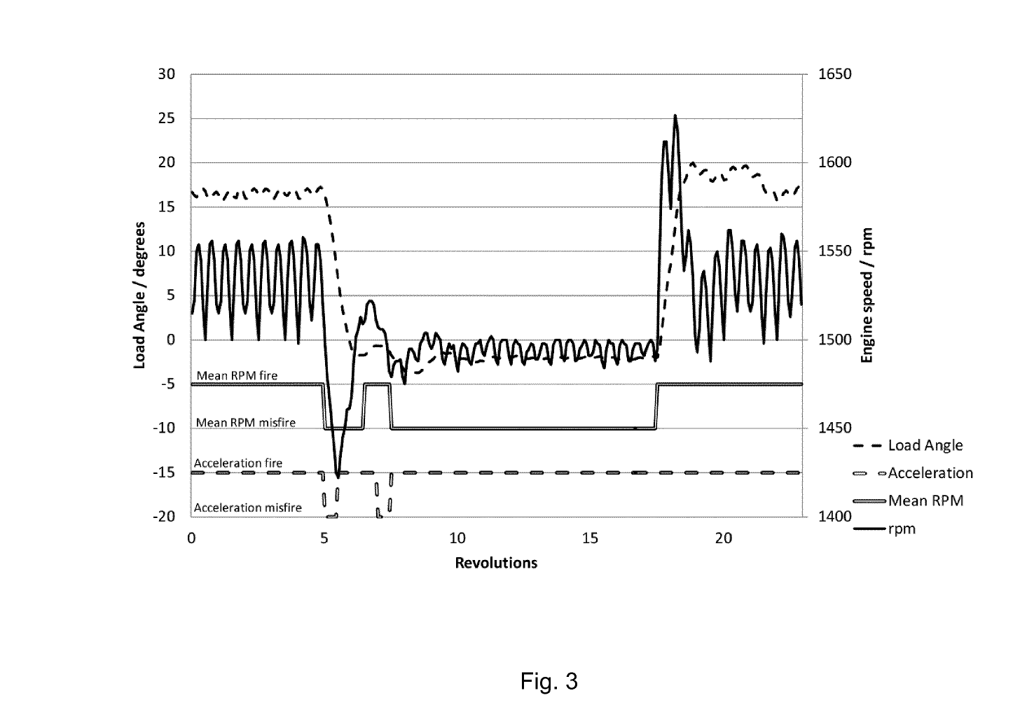

FIG. 3 illustrates the effect of continuous misfires on RPM and load angle for a similar engine generator.

For the purposes of the preferred embodiment, a misfire detection system (MDS) for an engine-generator is described in the context of an engine-generator for a combined heat and power (CHP) system, as shown in FIG. 1. The CHP system is connected to an electricity grid 1 to allow it to deliver power to the grid 1 and to receive a supply of reactive power from the grid 1. A sniffer 2 is used to measure the actual frequency from the grid 1. The sniffer 2 is a phase detector sensor that indicates the change in phase that occurs for each half sine wave. The MDS calculates the grid frequency over the last 15 complete sinusoidal waves. The engine-generator includes an engine 14 with a generator 13 coupled thereto. The generator 13 in this preferred embodiment is a four pole asynchronous generator and incorporates a rotor that is joined by a shaft 16 to the crankshaft of the engine 14. The generator 13 also includes a stator placed about the rotor. The engine-generator and CHP system may for example be as described in GB 2476482 or GB 2476483. Thus, heat is recovered from the engine 14 via heat exchangers at the engine 14 and in the exhaust system.

The engine 14 of this embodiment is a four cylinder four stroke engine such as the Toyota 4Y engine, which is operated using natural gas and a lambda 1 fuel-air ratio. The engine 14 receives fuel from fuel supply 9 via the carburettor 11, which mixes fuel and air to create an explosive gas mixture 12. After combustion the exhaust is vented to atmosphere via a flue 15. As explained above, it is important to ensure that the exhaust gas is not permitted to contain dangerous levels of uncombusted fuel.

The engine 14 is equipped with conventional crank and cam sensors, which detect rotational movement of the crankshaft and camshaft. The crank sensor in this preferred embodiment takes the form of twelve iron pegs 3 at equal angular intervals on the crank. These pegs 3 are detected by a magnetic pick-up sensor 4, which will hence provide six pulses per stroke to the MDS 5, i.e. twelve pulses per revolution of the crankshaft and twenty four pulses for an entire four stroke cycle. The MDS 5 is able to control the engine 14 and to initiate a shutdown of the engine 14 in response to detection of an unsafe misfire event, such as a number of misfires within a short time or a continuous misfire.

In this embodiment the shut-down of the engine 14 includes shutting off of the fuel using a gas valve 10 at the fuel supply 9. The MDS 5 monitors the signals from the sniffer 2 and crank pick-up sensor 4 and determines if potential misfires are occurring in excess of a predefined limit. The MDS 5 has a redundant architecture with both hardware and software incorporating repeated units 5a, 5b. The hardware includes separate microcontrollers controlling independent relay drivers 8a, 8b that connect to the valve 10 for the fuel supply 9. Cut-off of the fuel supply 9 can be triggered by either of the relays 8a, 8b. The relays 8a, 8b are normally open but remain closed as long as they receive an expected closing signal from the relevant hardware/software module 5a, 5b. The software on the two microcontrollers is arranged perform a reciprocal comparison every 100 ms via comparison unit 6 to confirm that both microcontrollers are operating correctly and producing the same result. The MDS 5 triggers shutdown of the engine 14 in the event that the reciprocal comparison 6 indicates that the two hardware or software systems 5a, 5b are not producing the same result.

When the shut down has been triggered by one or both modules 5a, 5b or by the comparison unit 6 then a manual reset is required before the engine 14 can be restarted. The system therefore includes a reset device 7 with a button that can be accessed by a service technician. In this embodiment the reset device 7 requires the button to be pressed for a certain period of time, for example 2 to 4 seconds. This minimises the risk of an accidental reset.

Two different routines are followed, which are discussed further below in conjunction with the misfire scenarios depicted in FIGS. 2 and 3. There is an evaluation of acceleration for each fire stroke using fire stroke evaluation modules 20a, 20b, and an comparison of engine RPM to a threshold value based on the grid frequency using mean RPM evaluation modules 21a, 21b. A misfire count module compares the number of detected misfires to a preset limit for a set number of strokes, which in this case might be a maximum of 8% misfires or each 600 strokes.

FIG. 2 shows a measurement of engine speed derived from the crank sensor 3, 4. The horizontal axis shows the pulses of the crank sensor 3, 4 and also indicates the firing of each cylinder of the four cylinder engine 14. The vertical axis is engine speed measured in RPM.

In the graphs shown in FIG. 2 the first three ignitions occur without misfire, and hence cylinders 1, 3 and 4 fire normally. Each fire generates an acceleration of the engine rotational speed from about 1500 RPM to about 1550 RPM during the first half of the ignition (firing) stroke. After this acceleration the engine rotation speed drops during compression of the next cylinder. Thus, in the first half of the stroke, the cylinder within its fire stroke dominates and engine speed increases, and in the second half of the stroke, the cylinder within its compression stroke dominates and engine speed decreases. In this normal firing part of the plot the RPM hence follows a regular cycle of acceleration and deceleration.

The fourth ignition is a misfire. Hence, after the third exhaust/compression stroke the expected acceleration does not occur. Instead the engine speed continues to decrease, until the next four stroke cycle begins and cylinder 1 fires correctly. The engine speed then recovers, albeit with some overspeed, during ignition in cylinders 3 and 4.

The MDS 5 monitors the crankshaft speed and detects changes in the engine rotation speed and/or the rate of change of engine rotation speed. The fire stroke evaluation modules 20a, 20b determine the acceleration a for each stroke n and compare this against an expected acceleration THR. When an expected acceleration occurs, as for the first four ignition cycles in FIG. 2, the MDS 5 logs this as a fire. If the expected acceleration does not occur, as for the fourth ignition cycle in FIG. 2, this is determined to be a potential misfire. The MDS 5 can be arranged to determine that the accelerations for the subsequent cycles represent a fire. Hence, for the eight ignition strokes shown in FIG. 2 the MDS 5 would count a single misfire.

The MDS 5 continuously monitors the engine speed and accelerations aₙ via the fire stroke evaluation modules 20a, 20b and counts potential misfires at the misfire count modules 22a, 22b based on the absence of an expected acceleration THR. The expected acceleration THR is an increase in speed by a set minimum over an ignition stroke, for example an increase of 30 or 40 RPM as a minimum, depending on the characteristics of the engine-generator. Potential misfires are summed over a set number of ignitions n, for example 600, and if the number of potential misfires exceeds 8% of ignitions then the MDS 5 triggers the safety mode of the engine-generator. This shutdowns the engine 14 and requires a manual reset before the engine 14 can be restarted.

The MDS 5 also monitors the pulses of the crank sensor and the cam sensor and correlates the detected potential misfire(s) to the cylinder that should have been firing. The MDS 5 can then indicate the cylinder or cylinders of the engine where misfires take place. Even when the misfires are not at a dangerous level the MDS 5 can thereby provide an indication of potentially damaged or faulty parts, such as damaged or worn out spark plugs, or damaged ignition components. This can be used to schedule repair and/or servicing in order to eliminate the source of a misfire before the misfire becomes regular enough to initiate a safety shutdown.

FIG. 3 illustrates another misfire scenario. In this case the engine 14 suffers a complete ignition failure for several four stroke cycles. This might be caused by a problem with the fuel-air mixture or by some general failure of the ignition system.

For the first five revolutions, which is ten ignition cycles for the exemplary four cylinder four stroke engine 14, each cylinder fires correctly. The engine 14 hence rotates at an average speed of just above 1500 RPM and the load angle is positive, since the engine 14 is pulling the generator 13 and hence generating electrical power. Subsequently there is a complete misfire. The engine speed drops significantly, but then recovers when the load angle becomes negative, since at this stage the generator 13 is acting as a motor and pulls the engine 14. The engine speed then settles at an average of just below 1500 RPM. The misfire event lasts for 12.5 revolutions and then all cylinders begin firing again. The engine speed increases and there is overspeed whilst both the firing cylinder and the generator 2 are powering the engine 1, before the engine speed settles to its normal steady state level of just above 1500 RPM and the load angle settles at its usual level as well.

The mean RPM evaluation modules 21a, 21b of the MDS 5 use a threshold value “sync” for engine rotational speed to check for a potential misfire event. In this example a threshold value of an average speed of below 1500 RPM is used, based on the synchronous speed of the generator 13 with a grid frequency at 50 Hz. When the engine speed RPMₙ drops below 1500 RPM then the mean RPM evaluation modules 21a, 21b indicate that a potential misfire has occurred for that ignition stroke n. The potential misfires are counted by the misfire count modules 22a, 22b and when the number of misfires in a set number of preceding ignition strokes n exceeds a set limit then the MDS 5 initiates a safety mode of the engine 13.

The MDS 5 adjusts the threshold value for engine speed in response to changes in the frequency of electricity production, since the generator speed will be set based on the required electricity frequency. Such changes occur due to variations in the grid frequency, which is common in some grid systems, for example in Russia. The MDS receive an indication of frequency from a phase detector. If the frequency drops then the normal steady state engine speed will decrease and so the threshold frequency is reduced accordingly. Similarly, an increase in frequency will prompt an increase in threshold engine speed.

The above described acceleration detection and threshold rotational speed techniques are used in combination, with a potential misfire being determined when the MDS 5 sees either an absence of an expected acceleration or an engine speed below the threshold level. The interaction of the two systems is illustrated by the two lines at the base of FIG. 3. The solid line at the base of FIG. 3 is at a high level when the mean RPM measurement does not indicate a potential misfire, and at a low level when the mean RPM evaluation modules 21a, 21b indicate that a potential misfire has occurred for a particular stroke or sequence of strokes. The dashed line at the base of FIG. 3 is at a high level when an expected acceleration occurs, and at a low level when an expected acceleration is not detected and the fire stroke evaluation modules 20a, 20b indicate a potential misfire.

When the misfires first occur, the expected acceleration is not present and also the engine RPM drops to below the threshold. Hence, at this point both the mean RPM evaluation modules 21a, 21b and the fire stroke evaluation modules 20a, 20b will detect a potential misfire at the fifth stroke. For the sixth stroke the engine 14 accelerates as a result of torque applied by the generator 13, and so the fire stroke evaluation modules 20a, 20b does not see a misfire. However, the mean RPM evaluation modules 21a, 21b still indicate a misfire and as a consequence the potential misfire is detected. The torque from the generator 13 increases the engine speed to above the threshold value by the seventh stroke, and so the mean RPM evaluation modules 21a, 21b do not see this misfire. However, since there is no acceleration for the seventh stroke then the fire stroke evaluation modules 20a, 20b will indicate a misfire. Subsequently, the engine speed settles to a value beneath the threshold, where the engine 14 is driven by the generator 13 in a steady state. Acceleration and deceleration occurs as the generator 13 works to compress the cylinders, and so the fire stroke evaluation modules 20a, 20b may detect an expected acceleration, as shown, and not detect a potential misfire. However, since the engine RPM in this state is below the threshold then the mean RPM evaluation modules 21a, 21b sees the misfire.

The MDS 5 can hence effectively detect both intermittent misfires and multiple or continuous misfires, and the two detection methods interact to ensure that all misfires are detected, even when there is a torque applied by the generator 13. When the number of strokes with potential misfires exceeds a set limit, which in this embodiment is 8% of the total number of strokes and is measured over the 600 preceding strokes, then this is deemed an unsafe misfire event and the engine 14 is shut down by means of the relays 8a, 8b and valve 10.

Whilst the misfire detection system has been described in this preferred embodiment in the context of a particular engine-generator combination it will be appreciated that the misfire detection system of the invention and preferred embodiments is not limited to this engine-generator combination. Alternative engine types or models and alternative generator types and models can also benefit from this misfire detection system. Any internal combustion engine in an engine-generator will suffer a reduced engine RPM in the event of a misfire. Hence the monitoring of engine RPM and indication of a potential misfire when this drops below a threshold can be applied to any internal combustion engine and not just the four cylinder engine described above. For example this method can be applied to a three cylinder engine or a six cylinder engine. In addition the misfire detection using movement of the crankshaft and camshaft can be applied to any engine with suitable crank and cam sensors.

1. An engine-generator comprising:
a generator,
an internal combustion engine coupled to the generator such that operation of the internal combustion engine will generate electricity via the generator, and
a control system incorporating a misfire detection system, the misfire detection system being arranged to monitor engine rotation speed in order to detect a misfire event during operation of the engine;
wherein in response to an indication of the misfire event the control system initiates a safety mode of the engine-generator.

2. An engine-generator as claimed in claim 1, wherein the engine-generator comprises a spark ignition engine using an air-fuel mixture with a lambda value of 1.5 or below.

3. An engine-generator as claimed in claim 1, wherein the safety mode includes cut-off of the fuel supply to the engine.

4. An engine-generator as claimed in claim 3, wherein the safety mode includes continuing engine rotation after cut-off of the fuel supply in order to expel uncombusted fuel to the atmosphere.

5. An engine-generator as claimed in claim 1, wherein the misfire event comprises a number of potential misfires exceeding a maximum permitted number, the potential misfires being determined based on the measurement of a rotational speed of the engine.

6. An engine-generator as claimed in claim 5, wherein the misfire detection system is arranged to indicate a misfire event if the number of ignition strokes with potential misfires exceeds 8% of strokes within a preset total number of strokes.

7. An engine-generator as claimed in claim 1, wherein the misfire detection system determines a potential misfire by determining if a cylinder fires correctly and identifies a potential misfire when an expected fire is not detected.

8. An engine-generator as claimed in claim 7, wherein the misfire detection system monitors the rotation speed of the crankshaft, with a potential misfire being indicated when an expected acceleration or increase in speed does not occur.

9. An engine-generator as claimed in claim 1, wherein the misfire detection system is arranged to measure the engine rotational speed, with a potential misfire being indicated when the engine rotational speed drops below a threshold value.

10. An engine-generator as claimed in claim 9, wherein the threshold value is set as a percentage below an expected engine rotational speed for steady state operation of the engine-generator.

11. An engine-generator as claimed in claim 9, wherein the threshold value is 1500 revolutions per minute (RPM).

12. An engine-generator as claimed in claim 9, wherein the misfire detection system is arranged to determine or adjust the threshold value based on the frequency of electricity in an electrical grid or network to which the engine-generator is connected.

13. An engine-generator as claimed in claim 1, wherein the misfire detection system is arranged to correlate each detected potential misfire and/or fire with pulses of the crank sensor or cam sensor and to hence determine the cylinder or cylinders of the engine where the misfire or fire takes place.

14. An engine-generator as claimed in claim 1, wherein the misfire detection system has a redundant software and/or hardware architecture.

15. A combined heat and power device including the engine-generator of claim 1.

16. A method of controlling an engine-generator comprising a generator and an internal combustion engine coupled to the generator such that operation of the internal combustion engine will generate electricity via the generator, the method comprising:
monitoring engine rotation speed;
determining the occurrence of potential misfires using the monitored engine rotation speed in order to thereby detect a misfire event during operation of the engine; and,
in response to an indication of the misfire event, initiating a safety mode of the engine-generator.

17. A method as claimed in claim 16, wherein the step of initiating the safety mode comprises shutdown of the engine, which is preferably a shutdown that requires a manual reset before the engine can be restarted.

18. A method as claimed in claim 16, wherein a misfire event is indicated when a number of potential misfires exceeds a maximum permitted number, the potential misfires being determined based on the monitoring of a rotational speed of the engine.

19. A method as claimed in claim 18, comprising indicating a misfire event if the number of ignition strokes with potential misfires exceeds 8% of strokes within a preset total number of strokes.

20. A method as claimed in claim 18, wherein the step of monitoring the rotation speed of the crankshaft comprises monitoring acceleration of the crankshaft, identifying if an expected acceleration or change in speed occurs, and hence determining that a potential misfire has occurred based on the absence of an expected acceleration or change in speed.

21. A method as claimed in claim 16, wherein the step of determining the occurrence of potential misfires comprises comparing the engine rotation speed to a threshold value, with a potential misfire being indicated by an engine rotation speed dropping below the threshold value.

22. A method as claimed in claim 21, wherein the engine rotational speed is measured as an average over a period of time or over a number of engine revolutions or ignition cycles.

23. A method as claimed in wherein the threshold value is set as defined in claim 10.

24. A method as claimed in any of claims 16 comprising correlating each detected potential misfire with pulses of the crank sensor or cam sensor and thereby determining the cylinder or cylinders of the engine where the misfire takes place.

25.-26. (canceled)
